(19) United States
(12) Patent Application Publication
(10) Pub. No.: US 2015/0015844 A1
(43) Pub. Date: Jan. 15, 2015

(54) Light filters that simulate the transmission spectra of the ocular lens pigment with age

(71) Applicants: James Martin Gallas, San Antonio, TX (US); John-Paul Lozano, San Antonio, TX (US); Abe Pena, Houston, TX (US)

(72) Inventors: James Martin Gallas, San Antonio, TX (US); John-Paul Lozano, San Antonio, TX (US); Abe Pena, Houston, TX (US)

(73) Assignee: Photoprotective Technologies, Inc., San Antonio, TX (US)

(21) Appl. No.: 14/331,022

(22) Filed: Jul. 14, 2014

Related U.S. Application Data
(60) Provisional application No. 61/957,825, filed on Jul. 12, 2013.

(51) Int. Cl. G02C 7/10; G02B 1/04

(52) U.S. Cl. CPC G02C 7/108; G02B 1/041
USPC 351/159.65

(57) ABSTRACT

This invention relates to the use of light filters, for example sunglass lenses, that have transmission spectra characteristic of the pigment found in the human ocular lens and that correspond to different age groups and different darkness.

This application claims the benefits of the early filing date of a corresponding provisional application: No. 61/957,825—Filing Date: Jul. 12, 2013 (Gallas and Lozano)

There is also a co-pending application: U.S. patent application (Gallas) “Light Filter that maximizes: Melatonin Production Factor; Eye protection factor; Scotopic Luminous transmission and Minimize Errors on the Fm100 color tests” (Provisional—filed 14 Jan. 2014; Ser. No. 13/999,867)

Inventors: James Gallas, John-Paul Lozano and Abe Pena

### BACKGROUND OF THE INVENTION

This invention relates to the use of light filters, for example sunglass lenses, that have transmission spectra characteristic of the pigment found in the human ocular lens; and that correspond to different age groups and different darkness.

Prior art has described ophthalmic lenses containing the pigment product resulting from the oligomerization of 3-hydroxykenumine (Gallas, U.S. Pat. No. 6,825,975)—for protecting vision from UV and High Energy Visible (HEV) Light. In U.S. Pat. No. 6,825,975 it was noted that the oligomerization product of 3-hydroxykynurenine accounted for the principal absorption of HEV light in the human ocular lens pigment. This prior art also described ability of these lenses to preserve the perception of color.

Prior art also described the use of UV-absorbing chromophores of the human lens (Benz U.S. Pat. Nos. 8,618,323 and 8,023,326); however, these pigments did not provide any significant HEV filtration.

The Gallas patent U.S. Pat. No. 6,825,975 described lenses made with the oligomerization product of 3-hydroxykynurenine that simulated the general characteristics of the transmission spectrum of the ocular lens: a smooth, curve with a sigmoidal shape from 400 nm to 700 nm. The lens samples made had a transmission spectrum that was similar in shape to an ocular lens from an individual of a particular age.

The Benz patents related to UV-absorbing chromophores that had limited ability to filter in the visible part of the wavelength spectrum.

Studies have shown that different people prefer computer and sunglass lenses with light-absorbing pigments that have different luminous transmission values. That is, some people prefer lightly-tinted lenses, while others prefer more darkly-tinted lenses—even under similar levels of ambient light intensities.

Recent research describes more accurately the change in the shape of the transmission spectra of the human ocular lens with age (FIG. 1). These spectra also show a progressive darkening of the human lens with age—that is, different luminous transmission values.

A pending provisional application (Ser. No. 13/999,867) by the Applicants also discloses a characteristic feature of the shape of the various optical density spectra of the ocular lens pigment common among the various age groups: The logarithm of the optical densities all form straight lines—but whose slopes increase with darkness and roughly with age.

Applicants also pointed out that in order to ensure that the color perception-preserving qualities of melanin and of the ocular lens pigment, it is necessary to ensure that the production or synthesis of these pigments have the characteristic straight lines in the logarithm of their optical density spectra with wavelength.

### BRIEF SUMMARY OF THE INVENTION

Applicants summarize here several useful features and opportunities that can be extracted from the preceding recent results:
1) The luminous transmission of the ocular lens decreases with age—that is, the lenses darken with age;
2) the shape of the spectra change with age;
3) the shape of the spectra suggest the dominant presence of the lower molecular weight fractions of 3OHKynurenine for the younger age groups and he higher molecular weight fractions for the older age groups.

It is an essential point of this invention that if the transmission spectrum of the ocular lens pigment is preferred because of the benefits of both efficient photoprotection to the retina and the preservation of color; and if, at the same time, people prefer lenses with different luminous transmission values; then it is reasonable to provide light filtration articles that mimic the light filtration of the ocular lens pigment with age—or darkness—as described in the features 1) and 2) above extracted from the recent research (by Artigas et al.) describing the transmission spectra of the ocular lens pigment with age.

The present invention therefore aims to define and produce commercial light filters whose transmission spectra replicate the shape of the transmission spectra of the ocular lens that occur with age and darkness by combining specific fractions of the oligomerization of 3 hydroxykynurenine and selected UV-absorbing monomeric units that occur in the human ocular lens.

The present invention further aims to incorporate these new compounds into light filters such as sunglass lenses, other ophthalmic lenses and light filters to protect and enhance vision from sunlight and artificial lighting.

### LIST OF FIGURES

FIG. 1. The transmission spectra of the human ocular lens for age groups 40-59.

FIG. 2. The transmission spectra of the human ocular lens for age groups 60-77.

FIG. 3. The absorption spectrum of 3OHK, 3OHCKA, and an oligomer of 3OHK

FIG. 4. The transmission spectrum of 3OHK, 3OHCKA, and an oligomer of 3OHK

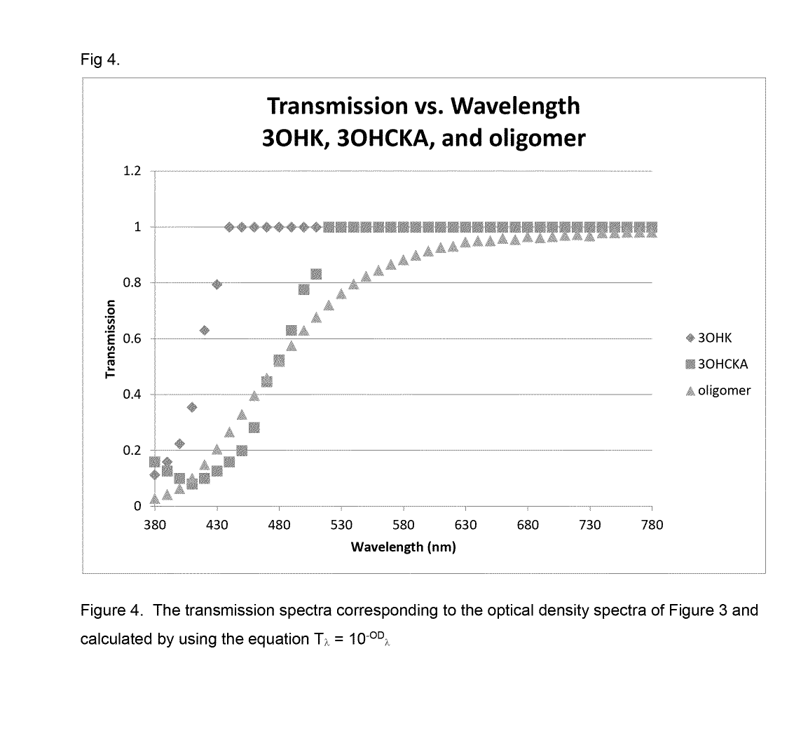

FIG. 5. Absorption spectra in the ultraviolet and visible region of an explanted human crystalline lens age 45 and a best fit

FIG. 6. Absorption spectra in the ultraviolet and visible region of an explanted human crystalline lens age 55 and a best fit

FIG. 7. Absorption spectra in the ultraviolet and visible region of an explanted human crystalline lens age 61 and a best fit

FIG. 8. Absorption spectra in the ultraviolet and visible region of an explanted human crystalline lens age 70 and a best fit

FIG. 9. Absorption spectra in the ultraviolet and visible region of an explanted human crystalline lens age 75 and a best fit

FIG. 10. Transmission spectra in the ultraviolet and visible region of an explanted human crystalline lens age 45 and a best fit

FIG. 11. Transmission spectra in the ultraviolet and visible region of an explanted human crystalline lens age 55 and a best fit

FIG. 12. Transmission spectra in the ultraviolet and visible region of an explanted human crystalline lens age 61 and a best fit

FIG. 13. Transmission spectra in the ultraviolet and visible region of an explanted human crystalline lens age 70 and a best fit

FIG. 14. Transmission spectra in the ultraviolet and visible region of an explanted human crystalline lens age 75 and a best fit

FIG. 15. The absorption spectra of various oligomers of 3-hydroxykynurenine (a-unbleached; b-bleached and c-derivatized and bleached)

FIG. 16. The transmission spectrum for and ophthalmic lens coated with a mixture of 3OHK, 3OHCKA, and oligomer in polyurethane water based coating, closely matching the transmission spectrum of a human ocular lens.

### DETAILED DESCRIPTION OF THE INVENTION

Consumer awareness of the multiple threats posed by exposure to the blue light component of outdoor and indoor lighting has grown sharply in recent years. In an epidemiological study in 2008, an increased exposure to sunlight was associated with an increased risk of macular Degeneration—for those subjects whose sampled blood serum showed a lower-than average level of anti-oxidants. The research team concluded that these results supported a blue light-induced photo-oxidation leading to the higher risk for age-related macular degeneration.

A more recent health threat—potentially greater than exposure to sunlight—may be associated with the increasing levels of ambient indoor lighting as a result of blue light-rich white LED lights that are rapidly replacing the blue light-scant incandescent light bulb because of legislation worldwide to reduce use of energy-wasting incandescent bulb. This transformation in our lighting system toward increasing amounts of environmental blue light is also being identified as one cause for the decreasing average in hours of sleep by people worldwide—because blue light has been shown to decrease the levels of night time production of melatonin, the body's sleep medicine. Loss of sleep has been shown to increase the risks of multiple diseases including diabetes, Alzheimer's, obesity and cancer.

The preceding trends are now heavily reported by the media worldwide and causing consumer awareness and a demand for the eye care industry to provide light filters (computer glasses, etc.) that reduce the blue light emitted by light sources and LED lights. However, the initial response by the industry is currently too conservative wherein the leading lens companies are reacting to the demand by reducing only a small amount of blue light. One reason for this hesitancy is the general tendency for yellow lenses (which selectively filter blue light) to disrupt the perception of color. There is also a cosmetic barrier to any tint on an ophthalmic lens—especially for yellow-tinted lenses. These considerations suggest a need for effective filtration of HEV light—that is, to filter only as much visible light as is necessary.

A unique feature of sunglass and computer glass lenses that contain melanin and ocular lens pigment is their ability to significantly reduce blue light without compromising the perception of color. They also filter the wavelengths of HEV light roughly in proportion to their ability to cause photochemical damage to the eye and roughly in proportion to the glare-causing wavelength components.

However, the spectrum of the ocular lens changes with age—as the lens also darkens with age. At the same time, consumers express a wide range of preferences for the darkness in sunglass lenses and also computer lenses.

It is an essential object of this invention to design and define the production of light-filtering agents that replicate the transmission spectra of the ocular lens for all age groups and all darkness.

In the First Embodiment of this invention, Applicants meet the objects of the invention by combining suitable amounts of the UV-absorbing and HEV-absorbing components that occur naturally in the human ocular lens, or which can be synthesized and fractionated as described further below.

### Definitions

UV light is the electromagnetic radiation having wavelengths that span the region of about 200 nm to 400 nm. Very little sunlight has a components in the region between 200 nm and 300 nm.

HEV light is the high energy visible region of the electromagnetic spectrum of wavelengths—between approximately 400 nm and 500 nm.

3OHK means 3-hydroxykynurenine.

3OHCKA means de-aminated 3-hydroxykynurenine

Oligomerization product 3-hydroxykynurenine means the material results of the auto-oxidation or enzymatic oxidation of 3-hydroxykynurenine.

Monomeric fractions of the oligomerization product 3-hydroxykynurenine means the monomer, 3-hydroxykynurenine;

Oligomeric fractions of the oligomerization product 3-hydroxykynurenine means the dimers, trimers, etc., and higher molecular weight fractions of oligomerization product 3-hydroxykynurenine

UV-absorbing monomeric units of the human ocular lens means the following UV-absorbing molecules: 3-hydroxykynurenine O-b-D-glucoside, 4-(2-amino-3-hydroxyphenyl)-4-oxobutanoic acid glucoside, glutathionyl-3-hydroxykynurenine glucoside, kynurenine, and 3-hydroxykynurenine.

Luminous transmission values of a light filtering agent have the same meaning as to those skilled in the art: the optical transmission—the average transmission of the light filtering agent, weighted by the spectrum of the light source (generally of the sun) and the spectrum of the sensitivity of the human eye.

RSS means the residual sum of squares. The mathematical description of RSS is defined for data points yᵢ and the associated model points fᵢ. Here i denotes any of the N referenced data points i=1, . . . , N. A small RSS—that is, a value close to zero—denotes a good fit of a model to the data points.

$$RSS = {\sum }_{i = 1}^{N} {( {y}_{i} - {f}_{i} )}^{2}$$

Reasonably matching means the optical density spectra of the ocular lens means that there will be a minimum of the residual sum of squares (RSS) between an optical density spectrum for the ocular age at selected age group or luminous transmission values (data) and the optical density spectrum obtained by constructing a linear combination of the optical densities of the monomeric and oligomeric units of 3-hydroxykynurenine, and the UV-absorbing monomeric units (model).

By definition, the linear combination of optical densities that provides the minimum to the RSS—that is, a value close to zero—is also the model that fits the data best. To explain further, if the data behaves in a linear fashion then the minimum RSS results in the largest coefficient of determination R², i.e. with a value near or equal to 1. A value of 1 indicates that the model perfectly fits the data. However, here we find that the optical density behaves in a nonlinear fashion which may make R² negative and so instead we must rely on the RSS to determine the best fit. In this invention we prefer a value for RSS to be no greater than 0.40.

### PREFERRED EMBODIMENTS

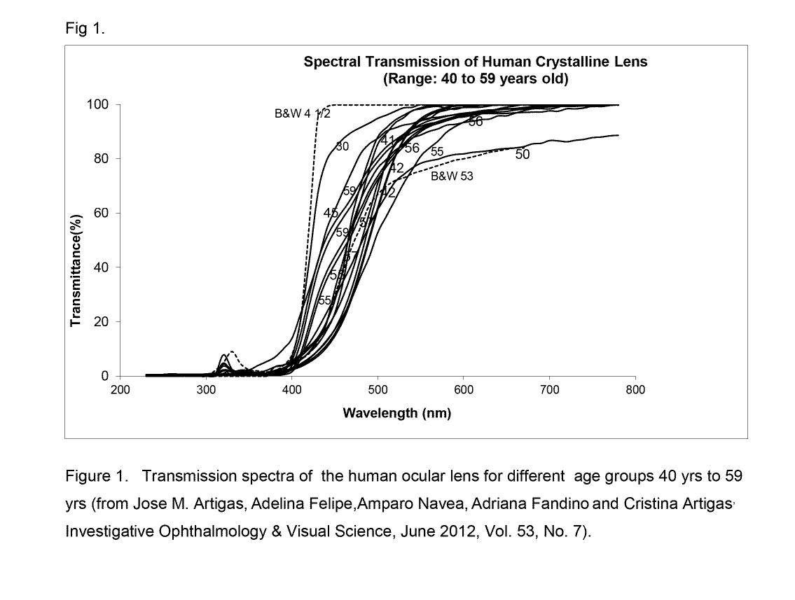

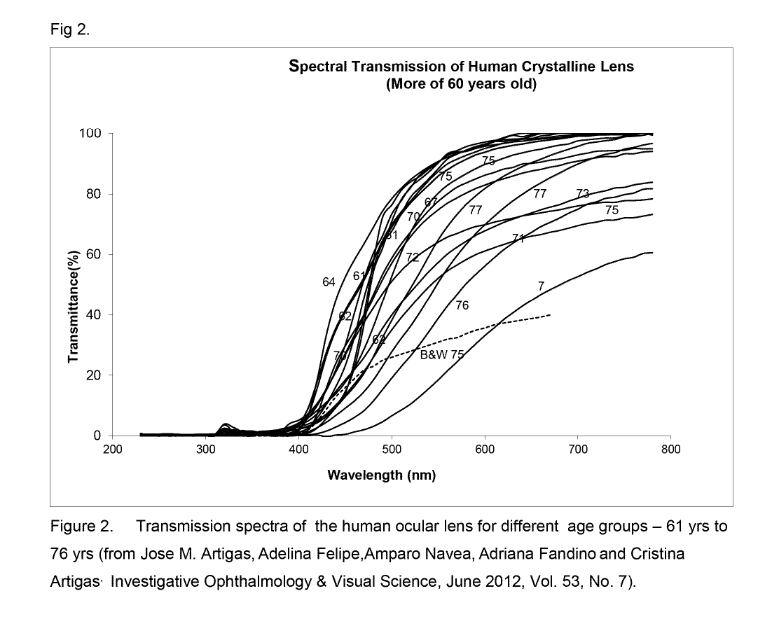

The juvenile lens is clear with little or no coloration. As the human lens ages, it becomes yellow, then darker, then increasingly yellow-brown. The transmission spectra of FIG. 1 and FIG. 2 show the average transmission spectra for various age groups that range from 40 years of age to 76 years of age. The biggest change occurs for the age group over 70 years of age.

The present invention proposes that the transmission spectra corresponding to these age groups can and should be replicated as a composite of specific monomeric and oligomeric fractions of 3 hydroxykynurenine and also the UV-absorbing monomeric units known to be present in the ocular lens. The invention illustrates how this can be done successfully in practice

The above objects will result in lenses with transmission spectra more similar to those of the ocular lens taught by Gallas and Benz and more comprehensively—for different ages—and will therefore be more desirable for use in ophthalmic eyewear.

In order to reduce to practice the aims of this invention and more fully replicate the spectra of the ocular lens pigment with age, the Applicants note the study (Snytnikova et al., 2008) that describe the UV-absorbing monomeric molecules identified in the cataractous human lens. It is noted in particular that the monomer of 3OHK is present in significant quantities and that its optical density spectrum is very similar in shape to all of the other monomeric UV-absorbers—particularly in the wavelength range between 380 nm and 500 nm—except for the de-aminated 3-hydroxykynurenine, 3OHCKA.

And a primary object of this invention is to identify and produce these specific oligomeric fractions and combine these fractions in various proportions in a manner that reasonably matches or replicates the shape transmission spectra of FIG. 1 and FIG. 2 with age.

### Simulation of the Transmission Spectra of the Ocular Lens Pigment with Age

In order to simulate the transmission spectra of FIG. 1 And FIG. 2 with age, Applicants have performed the combination of the above fractions by adding the optical densities of the fraction as follows:

It was assumed OD₈₀ =[a(OD_{3OHK})_{λ}+b(OD_{3OHCKA})_{λ}+c(OD_{oligomer})_{λ}]/[a+b+c]

Where, 3OHK means 3-hydroxykynurenine, 3OHCKA means de-aminated 3-hydroxykynurenine, and oligomer is one of the oligomers prepared from 3-hydroxykynurenine.

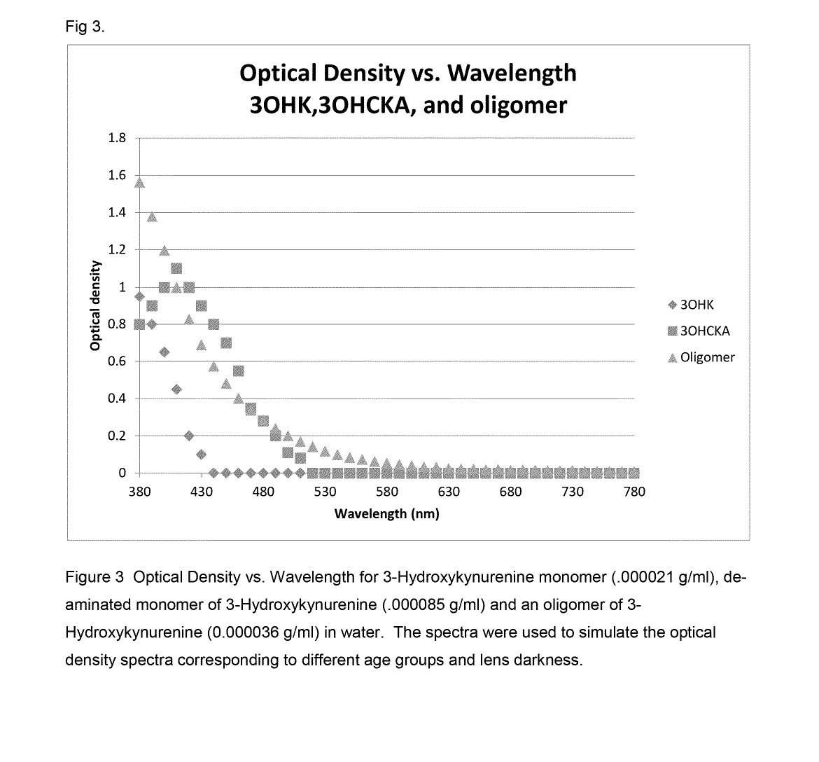

The optical density spectra for these components is shown in FIG. 3. Where the mass concentrations for these components are give respectively.

The coefficient a, b and c normalized by the term (a+b+c)—that is, a/(a+b+c), b/(a+b+c) and c/(a+b+c)—allowed the Applicants to vary the percent mass contributions of each of the components—3OHK, 3OHCKA, and oligomer.

A program in LabVIEW was written to compute a large number of terms for the simulated term ODλ above, wherein the values of a/(a+b+c), b/(a+b+c), and c/(a+b+c), were allowed to take on values from zero to 1 independently in such a way that their sum equaled, 1.0 or nearly 1.0.

For example OD₈₀=0.2(OD_{3OHK})₈₀ +0.1(OD_{3OHCKA})_{λ}+0.7(OD_{oligomer})_{λ}represents one such combination.

In the calculations, the optical density values for OD_{3OHKλ}, OD_{3OHCKAλ}, and OD_{oligomerλ}were taken from FIG. 3.

The preceding procedure generated a large number of spectra. These simulated spectra were compared with the data of FIGS. 1 and 2 after these transmission data were transformed into optical density spectra by using the equation OD_{λ}=−log T_{λ}.

A RSS calculation was used to obtain the best fits, or reasonably matched between the simulated spectra and the optical density data obtained from FIGS. 1 and 2.

The mathematical description of RSS is defined for data points yᵢ and the associated model points fᵢ. Here i denotes any of the N referenced data points i=1, . . . , N. A small RSS—that is, a value close to zero—denotes a good fit of a model to the data points.

$$RSS = {\sum }_{i = 1}^{N} {( {y}_{i} - {f}_{i} )}^{2}$$

Reasonably matching means the optical density spectra of the ocular lens means that there will be a minimum of the residual sum of squares (RSS) between an optical density spectrum for the ocular age at selected age group or luminous transmission values (data) and the optical density spectrum obtained by constructing a linear combination of the optical densities of the monomeric and oligomeric units of 3-hydroxykynurenine, and the UV-absorbing monomeric units (model).

By definition, the linear combination of optical densities that provides the minimum to the RSS—that is, a value close to zero—is also the model that fits the data best. To explain further, if the data behaves in a linear fashion then the minimum RSS results in the largest coefficient of determination R², i.e. with a value near or equal to 1. A value of 1 indicates that the model perfectly fits the data. However, here we find that the optical density behaves in a nonlinear fashion which may make R² negative and so instead we must rely on the RSS to determine the best fit. In this invention we prefer a value for RSS to be as small as possible.

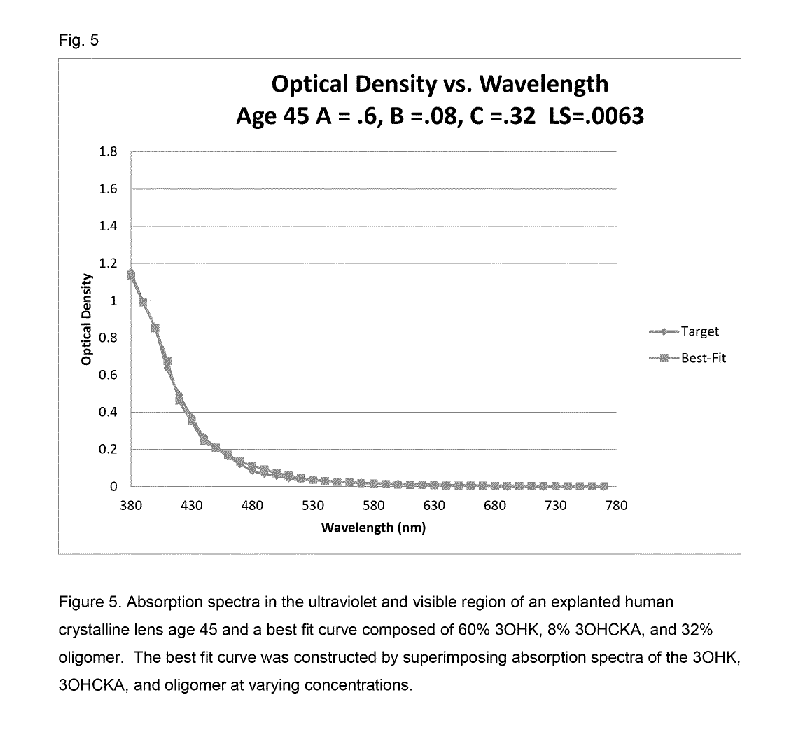

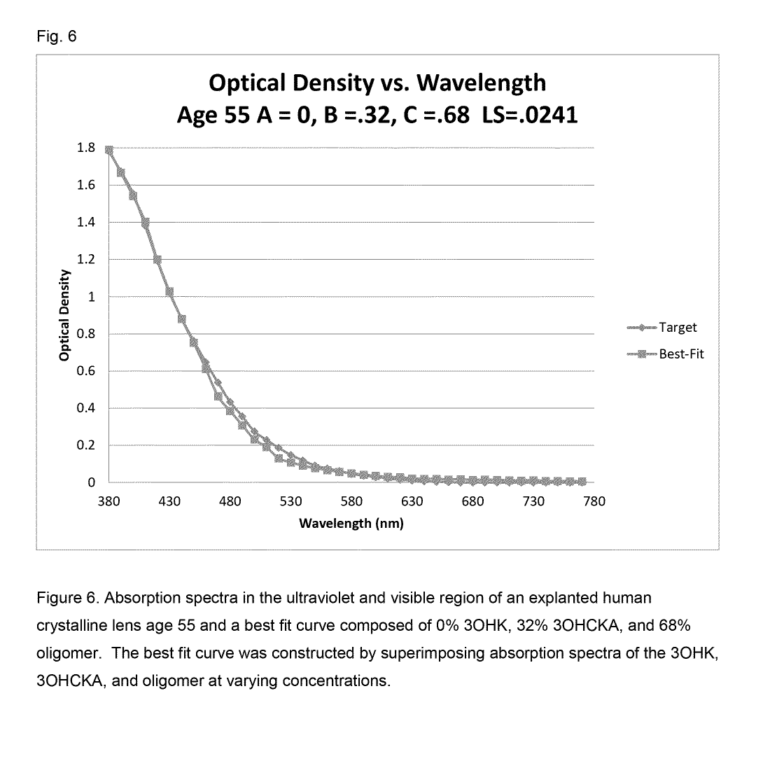

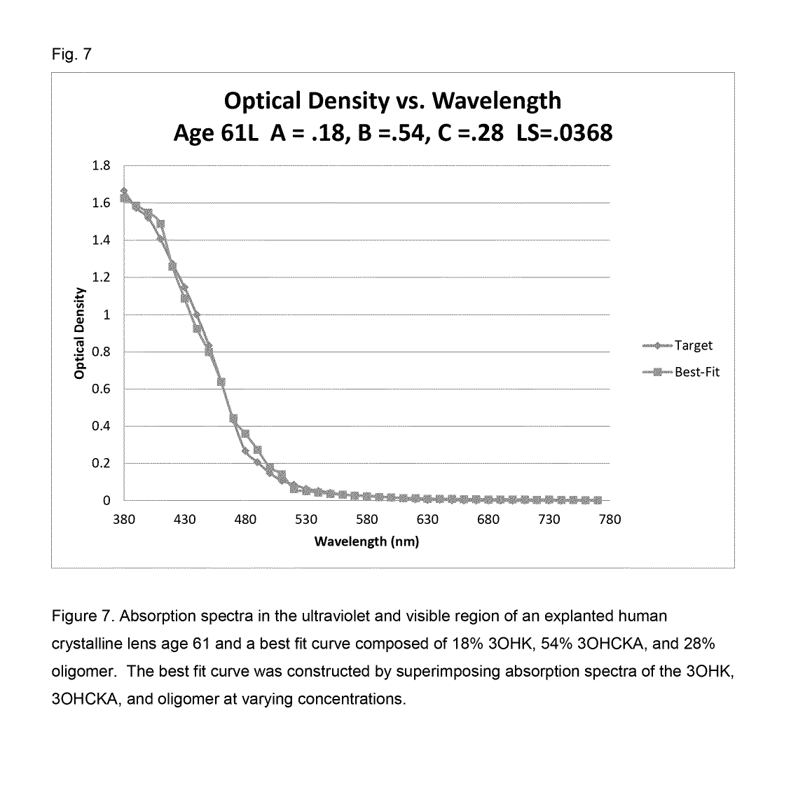

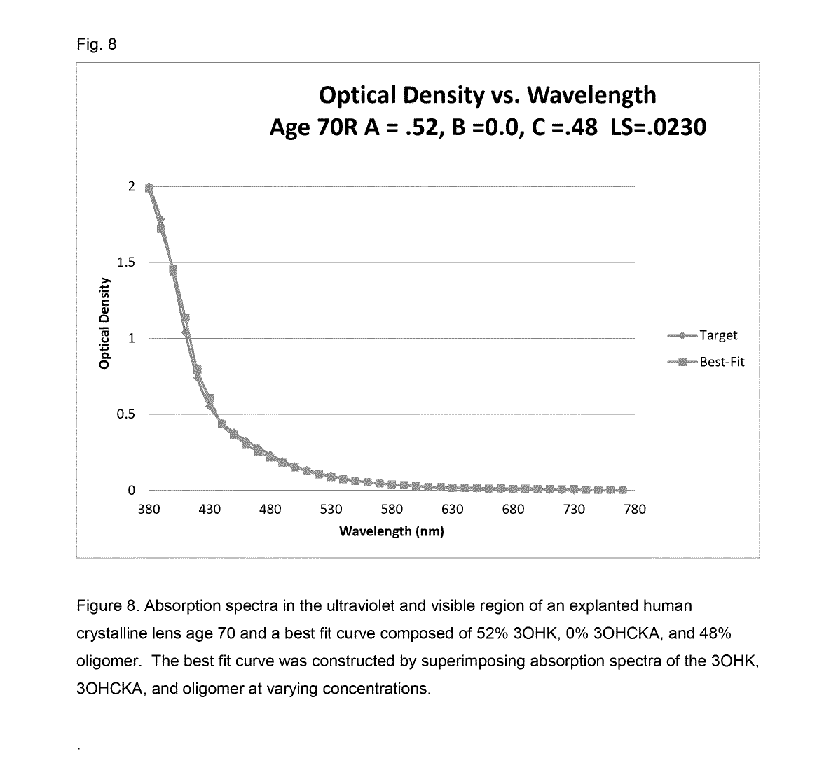

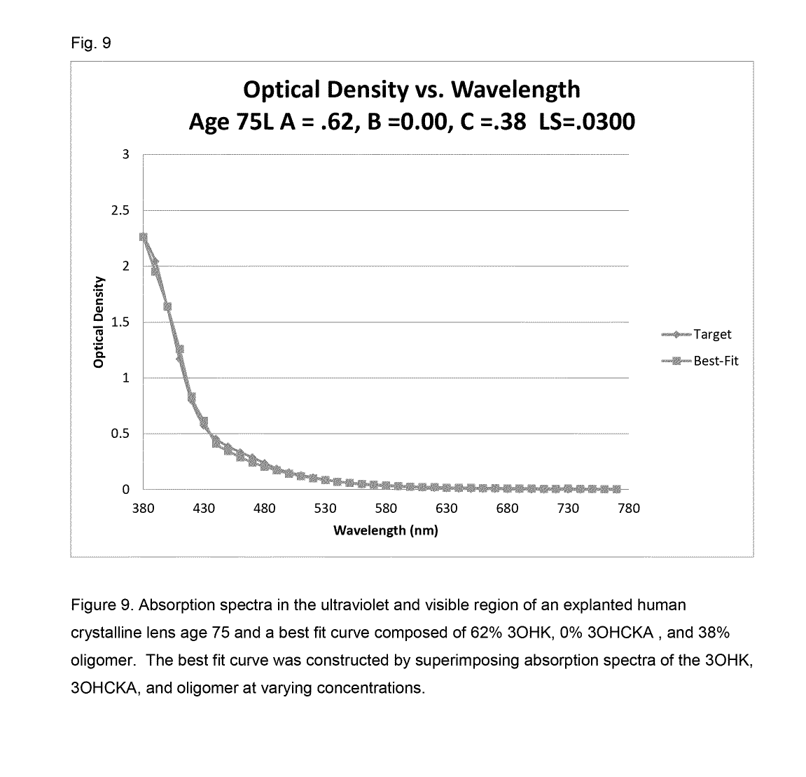

These results are summarized for 5 different age groups that span the range from 45 years to 75 years in FIG. 5 through FIG. 9 inclusive.

A preferred range for the RSS values is less than 0.40 for a reasonable match between the simulated spectra and the spectra recorded for the actual ocular lens transmission data.

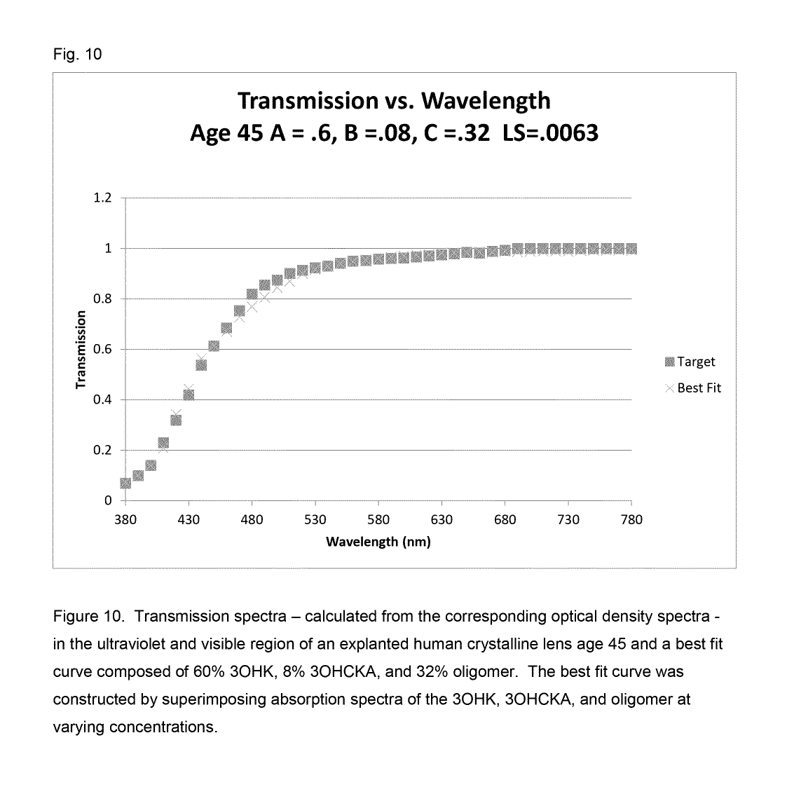

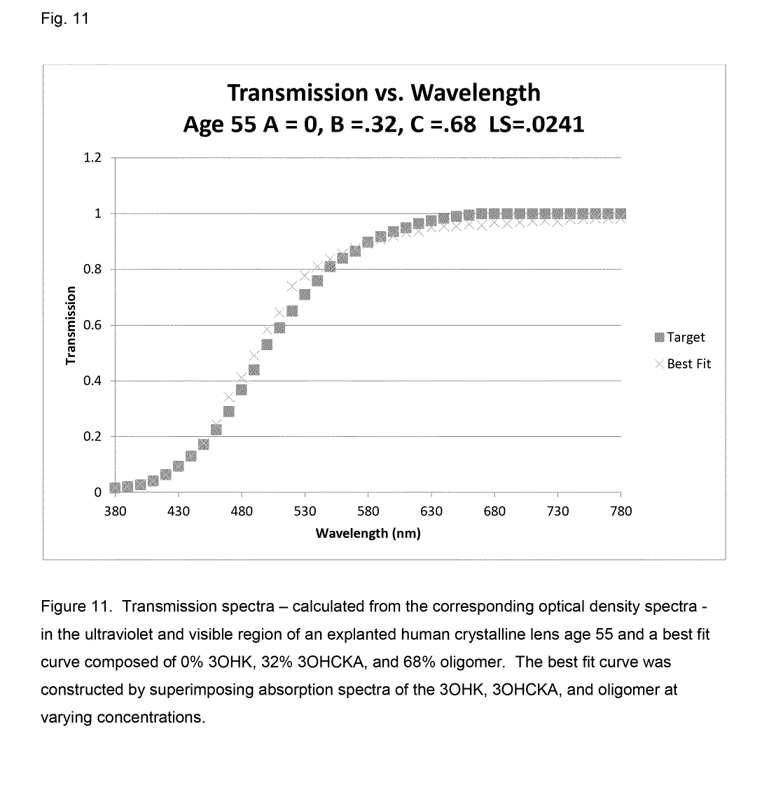

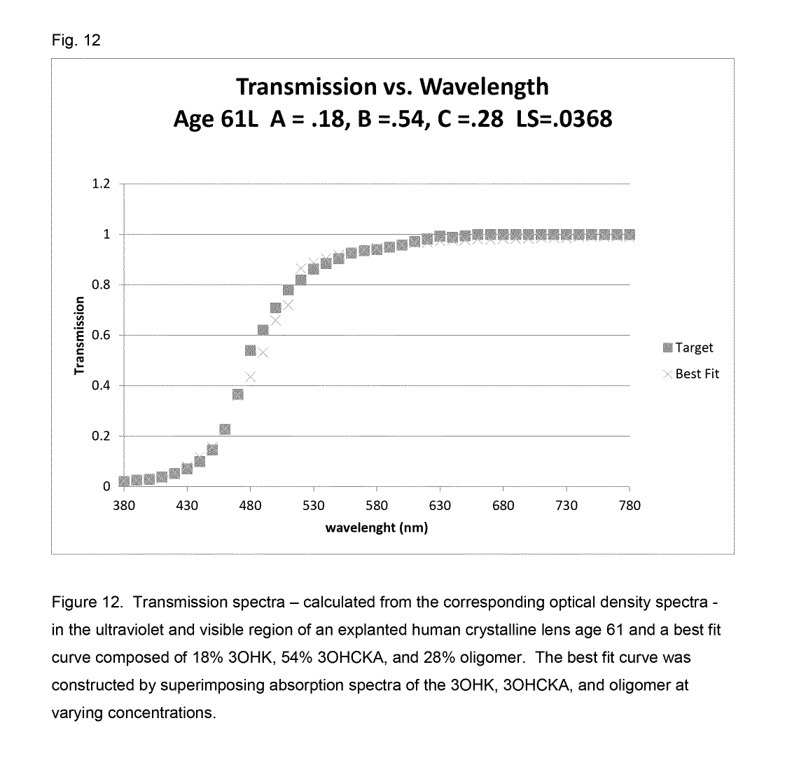

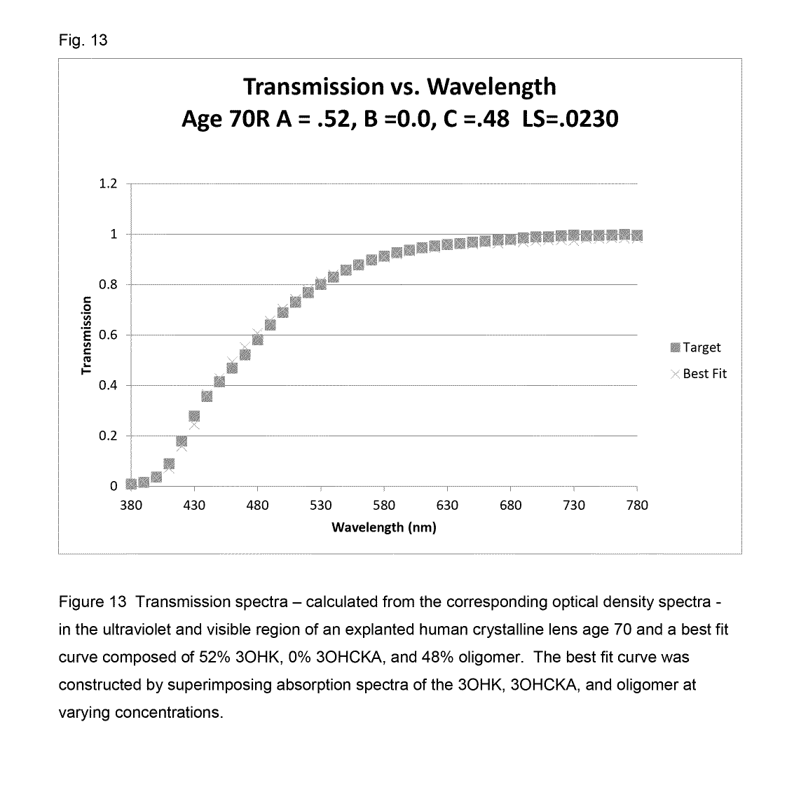

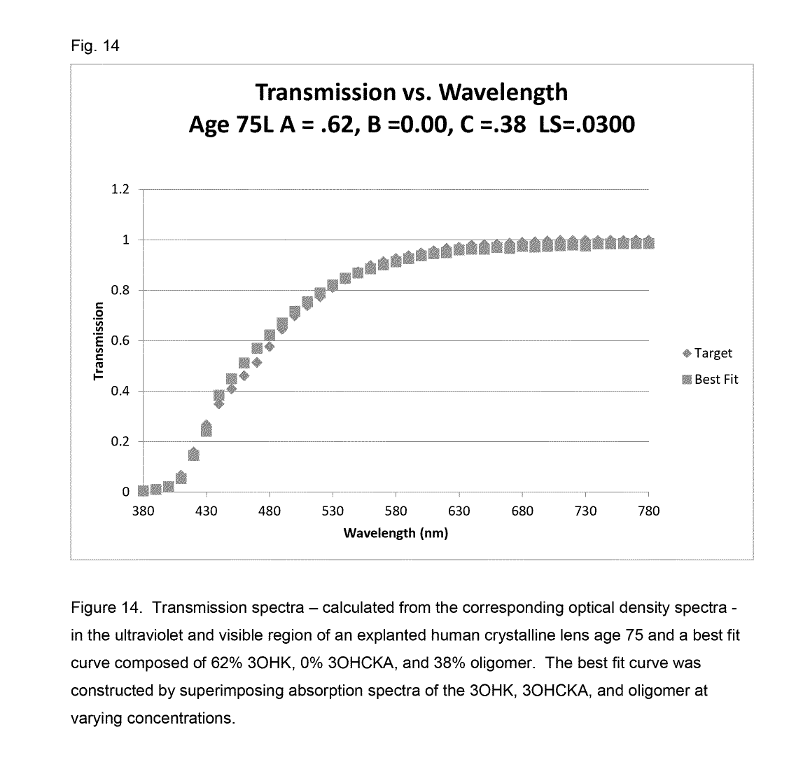

The corresponding transmission spectra for these optical densities is shown in FIG. 10 through FIG. 14.

### Example 1

### Synthesis of Heterogeneous Oligomer of 3-hydroxykynurenine

As a specific example, a) 2.5 grams of 3-Hydroxykynurenine were dissolved in IL of de-ionized water, b) 0.07 g of ferric chloride, FeCl3, was dissolved in 250 cc of de-ionized water; and c) 6.1 g of potassium persulphate were dissolved in 250 cc of de-ionized water; then a), b) and c) were each heated to 50 degrees C.; then solution b) was added to a) to produce solution d) and stirred; then solution c) was added to d) drop-wise over a period of 5 minutes and the final solution was allowed to stir, under a condenser, at 50 degrees C. for 24 hours. The reaction mixture was then dialyzed to remove reaction salts and immediately lyophilized.

### Example 2

### Coatings of the Mixtures

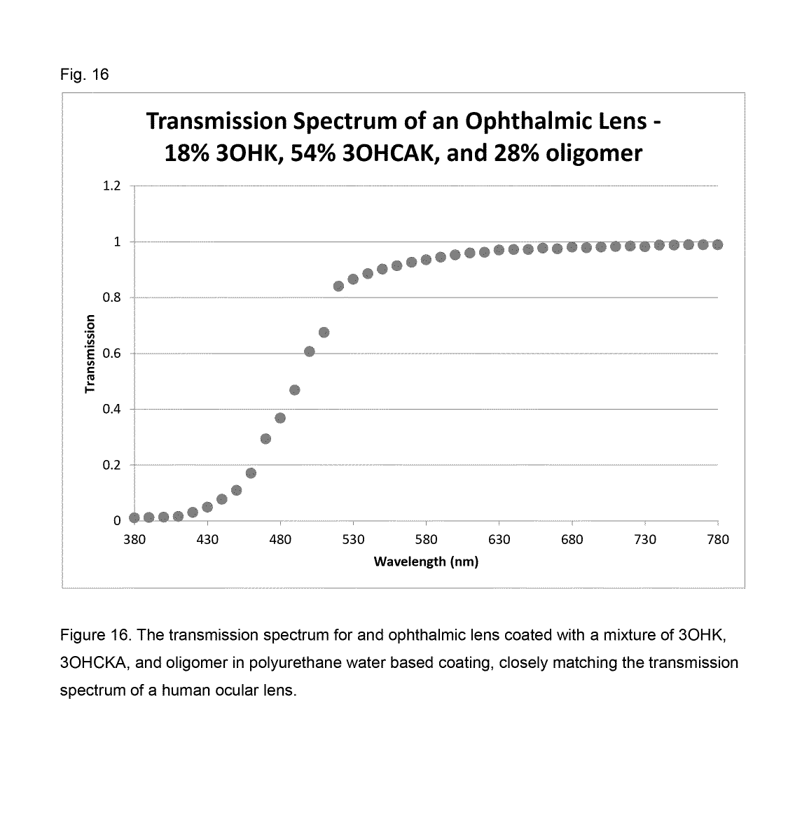

Coatings containing a mixture of 3OHK, 3OHCKA, and an oligomer with concentrations of 0.00013 g/ml, 0.00051 g/ml, and 0.00022 g/ml respectively. Coatings were made by dispersing these powders according to the fractions described in a waterborne, hydrophilic coating resin (HD6002—provided by Hauthaway Corp). Transparent plano polycarbonate ophthalmic plastic lenses were dipped into the above dispersions and the liquid coatings were allowed to air dry and then baked in an oven at 100 degrees C. for 2 hours. The transmission spectrum of one of these lenses is shown in FIG. 16.

### SECOND PREFERRED EMBODIMENT

In the second Preferred Embodiment, Applicants meet the Objects of this invention through the use of synthetic dyes not present in the ocular medium. This can be achieved by selecting dyes and pigments that have transmission spectra that are similar to the spectra of FIG. 3. For the case of the oligomeric fractions, there are several materials that can be used including, but not limited to melanin, asphaltenes and maltenes, polyphenols, lignins and small molecular weight fractions of carbon black. For the selection of dyes having transmission spectra similar to those of 3OHK and 3OHCKA, a variety of UV-absorbing dyes that have optical absorption maxima that extend from the UV region onto the violet and blue region of wavelengths and which reasonably match the spectra of FIG. 3 can be combined with relative amounts selected so that the spectra of their combination reasonably matches the Figures—as in the First Preferred Embodiment.

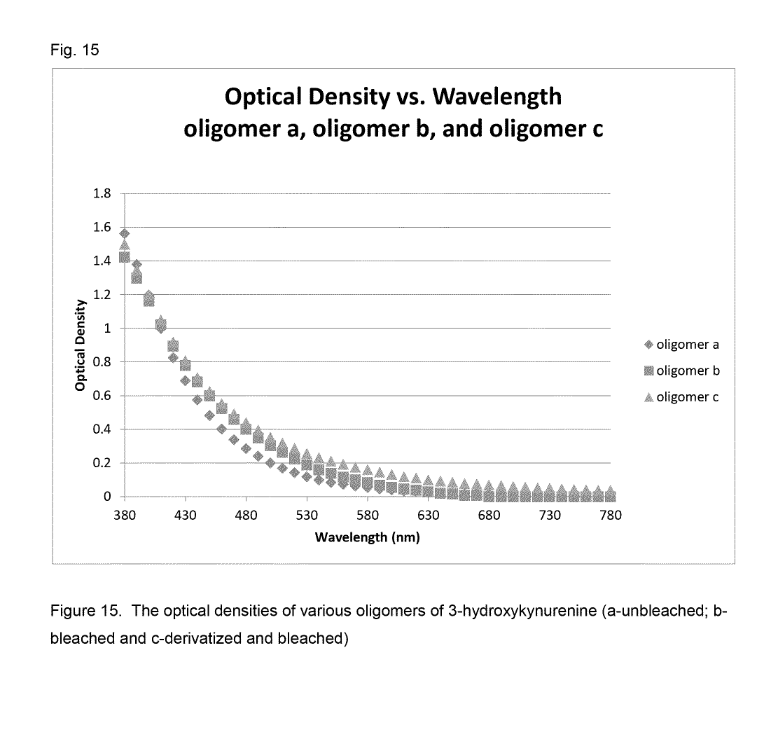

Other ways to simulate the spectra of the transmission spectra of the ocular lens pigment with age is to use different forms of the oligomer of 3-Hydroxykynurenine. This is possible by using a fractionated form of the polymerization product of 3-Hydroxykynurenine. The optical densities of such fractionated oligomers are shown in FIG. 15.

### CONCLUSION

It is an essential point of this invention that if the transmission spectrum of the ocular lens pigment is preferred because of the benefits of both efficient photoprotection to the retina and the preservation of color; however this spectrum changes with age—both in shape and in the average, luminous transmission. At the same time, people prefer lenses with different luminous transmission values. Applicants have been able to replicate the changing transmission spectra that occurs with age by superposing the optical densities of specific monomeric and oligomeric fractions of 3 hydroxykynurenine and also the UV-absorbing monomeric units known to be present in the ocular lens.

1. A light filter consisting of: a transparent substrate; and a light filtering agent wherein the light filtering agent is a combination of monomeric and oligomeric fractions of the oligomerization product 3-hydroxykynurenine and the UV-absorbing monomeric units of the human ocular lens

2. A light filter according to claim 1, where the transparent substrate is a plastic ophthalmic lens.

3. A light filter according to claim 1, where the transparent substrate is a plastic film or sheet.

4. A light filter consisting of: a transparent substrate; and a light filtering agent wherein the light filtering agent is a combination of monomeric and oligomeric fractions of the oligomerization product 3-hydroxykynurenine and the UV-absorbing monomeric units of the human ocular lens and wherein the various said fractions are weighted in their concentrations so that said light filtering agents have optical density spectra that reasonably match the shape of the optical density spectra of the ocular lens having selected luminous transmission values.
